(19) United States
(12) Patent Application Publication
(10) Pub. No.: US 2009/0113314 A1
(43) Pub. Date: Apr. 30, 2009

(54) LOCATION AND PLACEMENT OF AVATARS IN VIRTUAL WORLDS

(76) Inventors: Christopher J. Dawson, Arlington, VA (US); Rick A. Hamilton II, Charlottesville, VA (US); Michael D. Kendzierskl, New York, NY (US); James W. Seaman, Falls Church, VA (US)

Correspondence Address: IBM CORPORATION (JSS);C/O SCHUBERT OSTERRIEDER & NICKELSON PLLC, 6013 CANNON MOUNTAIN DRIVE, S14, AUSTIN, TX, 78749, US

(21) Appl. No.: 11/928,771

(22) Filed: Oct. 30, 2007

(51) Int. Cl. G06F 3/048

(52) U.S. Cl. 715/757

(57) ABSTRACT

Methods and arrangements of locating objects in virtual worlds are discussed. Embodiments include transformations, code, state machines or other logic to receive from a user a criterion for gathering information from sources external to a virtual world and automatically gathering information based upon the criterion. The information may include contact information of potential participants in the virtual world. The method may include aggregating data for determining a placement of an avatar of the user in the virtual world and transmitting the data. In some embodiments, the method may involve identifying an avatar of another participant in the virtual world on the basis of the contact information. In many embodiments, the method may involve determining a location for the location of the avatar of the user based upon the contact information. In several embodiments, the information gathering may be performed by a local software agent.

### FIELD

The present invention is in the field of virtual worlds. More particularly, the present invention relates to methods and arrangements to locate and place avatars in virtual worlds based upon automatically gathered information external to the virtual worlds.

### BACKGROUND

A virtual world is a computer-based simulated environment. The environment may resemble the real world, with real world rules such as gravity, topography, and locomotion; and with social and economic interactions between characters. Users may be represented as avatars, two or three-dimensional graphical representations. Many virtual worlds allow for multiple users and provide for communications between the users. Virtual worlds may be used for massively multiple player online role-playing games, for social or business networking, or for participation in imaginary social universes.

Virtual worlds may provide a useful environment for personal interactions, both business and social. Avatars in virtual worlds can have a wide range of business and social experiences, and such experiences are becoming more important as business and social transactions are becoming common in virtual worlds. In fact, the characteristics of an avatar may play important social, business, and other related roles in virtual worlds. One example is Second Life (SL), a privately owned 3-D virtual world, made publicly available in 2003 by Linden Lab. The SL virtual world is computed and managed by a large array of servers that are owned and maintained by Linden Lab. The SL client program provides its users, referred to as residents, with tools to view, navigate, and modify the SL world and participate in its virtual economy. In 2006, SL had over one million residents. Social and business interactions are important in SL, and these interactions include resident interactions in both personal and business meetings.

With the increase in the number of users that are members of virtual worlds, it is becoming more and more unlikely to be in the same virtual location as friends or colleagues. For example, suppose an avatar knows ten other avatars within a Virtual World. When the virtual world consisted of less than 1000 inhabitants and covered a small virtual land mass, the likelihood of meeting other familiar avatars was high. As virtual worlds increase in number of inhabitants and virtual area, this likelihood is drastically reduced. Finding a familiar avatar may be analogous to visiting New York City and expecting to serendipitously encounter friends.

A participant in a virtual world may have information obtained from outside the virtual world environment that would be useful for locating friends, colleagues, business associates, or other acquaintances in the virtual world. The participant may have accounts with various social networking sites, which may track lists of friends and links. Similarly, the participant's address book and instant message history may contain contact information of acquaintances the participant may desire to meet in the virtual world.

In the current art, for a participant to place an avatar and other virtual world objects near desired contacts may require a large amount of effort. The participant may have to manually copy information about desired contacts in the virtual world. The participant may be forced to constantly move in and out of the virtual world to duplicate the information inside the virtual world. For example, an SL participant may enter contact information about another SL participant into an Outlook Express address book. The contact information may include telephone numbers, address and a SL avatar name. The participant may then enter the SL virtual world to interact with other SL avatars. In the current art, to communicate with the other participant, the participant may have to enter Outlook Express to view the address book. Accessing the address book may require logging out of SL, using a different computer, or using a different screen. The participant may then write down the avatar name for the new contact and re-enter SL.

In addition, the participant may search for the acquaintances in the virtual world on the basis of the contact information. There may be difficulties in translating from the contact information to virtual world identifications. For example, an instant message address may not be similar to an avatar name or an actual name. Further, determining a location near the greatest number of contacts may involve running through a long list of contacts to determine which are currently present in the virtual world and where they are located.

### SUMMARY OF THE INVENTION

The problems identified above are in large part addressed by methods and arrangements of locating avatars and other objects in virtual worlds. One embodiment provides a method of locating avatars and other objects in virtual worlds. The method may involve receiving from a user a criterion for gathering information from sources external to a virtual world and automatically gathering information based upon the criterion. The information may include contact information of potential participants in the virtual world. The method may include aggregating data for determining a placement of an avatar of the user in the virtual world and transmitting the data. The method may include using the data collected from external sources to locate and place a user's avatar in proximity to familiar avatars in the virtual world.

### BRIEF DESCRIPTION OF THE DRAWINGS

Advantages of the invention will become apparent upon reading the following detailed description and upon reference to the accompanying drawings in which like references may indicate similar elements:

FIG. 1 depicts an embodiment of a networked system of devices capable of locating objects in virtual worlds;

FIG. 2 depicts an embodiment of a computer capable of locating objects in virtual worlds;

FIG. 3A depicts an embodiment of an apparatus to gather information for locating objects in virtual worlds;

FIG. 3B depicts a virtual world capable of positioning objects of a user based upon information automatically gathered from sources external to the virtual world;

FIG. 4 depicts a flowchart of an embodiment of a method to locate objects in virtual worlds; and

FIG. 5 depicts an embodiment of the distribution of avatars throughout a virtual world.

### DETAILED DESCRIPTION OF EMBODIMENTS

The following is a detailed description of embodiments of the invention depicted in the accompanying drawings. The embodiments are in such detail as to clearly communicate the invention. However, the amount of detail offered is not intended to limit the anticipated variations of embodiments; but on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, methods and arrangements of locating objects in virtual worlds are contemplated. Embodiments include transformations, code, state machines or other logic to receive from a user a criterion for gathering information from sources external to a virtual world and automatically gathering information based upon the criterion. The information may include contact information of potential participants in the virtual world, the gathering external to the virtual world. The method may include aggregating data for determining a placement of an avatar of the user in the virtual world and transmitting the data. The method may include using the data collected from external sources to locate and place a user's avatar in proximity to familiar avatars in the virtual world.

While specific embodiments will be described below with reference to particular circuit or logic configurations, those of skill in the art will realize that embodiments of the present invention may advantageously be implemented with other substantially equivalent configurations.

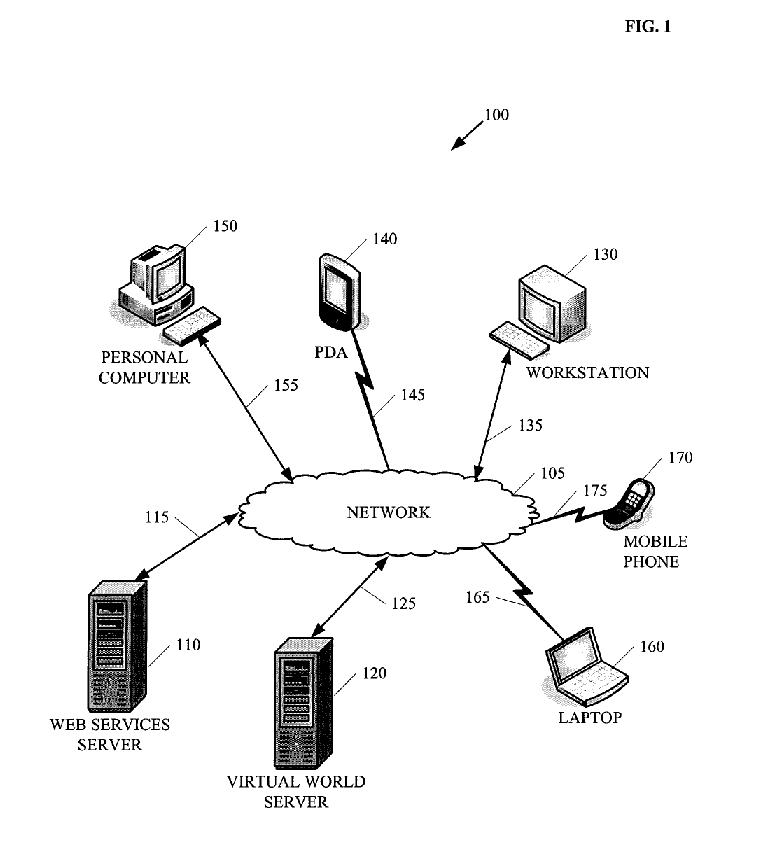

FIG. 1 depicts a diagram of an embodiment of a networked system 100 of devices capable of locating objects in virtual worlds. The system 100 includes a network 105, web services server 110 connected to network 105 through wireline connection 115, virtual world server 120 connected to network 105 through wireline connection 125, and a variety of computing devices capable of locating objects in virtual worlds, including:
workstation 130, a computer coupled to network 105 through wireline connection 135,
personal digital assistant 140, coupled to network 105 through wireless connection 145,
personal computer 150, coupled to network 105 through wireline connection 155,
laptop computer 160, coupled to network 105 through wireless connection 165; and
mobile phone 170, coupled to network 105 through wireless connection 175.

The devices 130, 140, 150, 160, and 170 may receive from a user a criterion for gathering information and automatically gather information from sources external to a virtual world based upon the criterion. The information may include contact information of potential participants in a virtual world. Based upon the information, the devices may aggregate data for determining a placement of an avatar or other object of the user in the virtual world and transmit the data.

Network 105, which may consist of the Internet or another wide area network, a local area network, or a combination of networks, may provide data communications among web services server 110, virtual world server 120, and the devices 130, 150, 140, 160, and 170.

Web services server 110 may have installed and operative upon it software to perform web services. Web services present a standardized way of integrating web-based applications. Web services typically provide business services upon request through data communications in standardized formats called bindings. A binding is a specification of a data encoding method and a data communications protocol. The most common binding in use for web services is data encoding in XML according to the SOAP protocol and data communications with HTTP. SOAP (Simple Object Access Protocol) is a request/response messaging protocol that supports passing structured and typed data using XML and extensions.

Web services are often delivered by use of multi-node transactions carried out through the use of web services intermediaries. Web services intermediaries are web services components, typically a server, that lie between a web services requester and a web services ultimate destination server that delivers the web service. Intermediaries operate generally by intercepting a request from a client, optionally providing intermediary services, and then forwarding the request to an ultimate destination web services provider.

Web services server 110 may receive from one of the devices 130, 140, 150, 160, and 170 a request to determine a location for placing a user's avatar or other objects in the virtual world maintained by virtual world server 120. The user may, for example, desire to appear near friends in the virtual world. Web services server 110 may process the request, acting as an intermediary between the user and the virtual world.

Different embodiments may feature different amounts of information exchanged between one of the devices, web services server 110, and virtual world server 120. In some embodiments, the request may contain contact information gathered from sources outside of the virtual world. In some further embodiments, web services server 110 may reformulate the contact information and transmit it to virtual world server 120. Virtual world server 120 may return a list of avatars corresponding to the contact information and their current locations in the virtual world, if any. Web services server 110 may again reformulate the list and transmit it to the computing device of the user. The computing device may determine a location for the user's avatar based upon the list and the locations. In other further embodiments, the request may contain a user's weighting scheme for locating an avatar near the avatars of the contacts. Web services server 110 may directly determine a location for the user's avatar, or may forward the weighting scheme to the virtual world server 120 for its determination of a location. In several embodiments, a computing device may translate contact information into avatars. In these embodiments, the request to web services 110 may contain a list of avatars that the user desires to encounter in the virtual world.

Virtual world server 120 may have installed and operative upon it software to implement a virtual world. A virtual world is a computer-based simulated environment. The environment may resemble the real world, with real world rules such as gravity, topography, and locomotion. Users may be represented by two or three-dimensional graphical representations called avatars. Many, but not all, virtual worlds allow for multiple users. Avatars may communicate by text or by real-time voice communication using VOIP. Virtual world are often used in massively multiplayer online role-playing games such as EverQuest, Ultima Online, Lineage, World of Warcraft, or Guild Wars. Other virtual worlds provide for simulated economic and social interaction in environments where the focus is more on the participation and less on winning and losing. These virtual worlds include Active Worlds, There, Second Life, Entropia Universe, The Sims Online, Kaneva, and Weblo. Still other virtual worlds may provide a social networking experience. A user may enter some virtual worlds to share favorite blogs or other web sites with other participants.

Virtual world server 120 may maintain data about participants and their current locations. The data about the participants may include contact information, such as names and email addresses. A virtual world may be subdivided into regions. A region may be a connected area which an avatar can pass through in steps, such as walking steps. Travel from one region to another may require a special mode of transportation, such as teleportation. Teleportation may involve instantaneous travel from one location to a far distant location.

The arrangement of web services server 110, virtual world server 120 and other devices making up the exemplary system 100 illustrated in FIG. 1 is for explanation, not for limitation. Data processing systems useful according to various embodiments of the present invention may omit a server, or may include additional servers, routers, other devices, and peer-to-peer architectures, not shown in FIG. 1, as will occur to those of skill in the art. In some embodiments, a computing device such as one of devices 130, 150, 140, 160, and 170 may communicate directly with a virtual world server device, without using a web service such as web service server 110 as an intermediary. In some other embodiments, there may be multiple web services intermediary between a user's computing device and a virtual world. In many other embodiments, programs other than web services may act as an intermediary.

Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

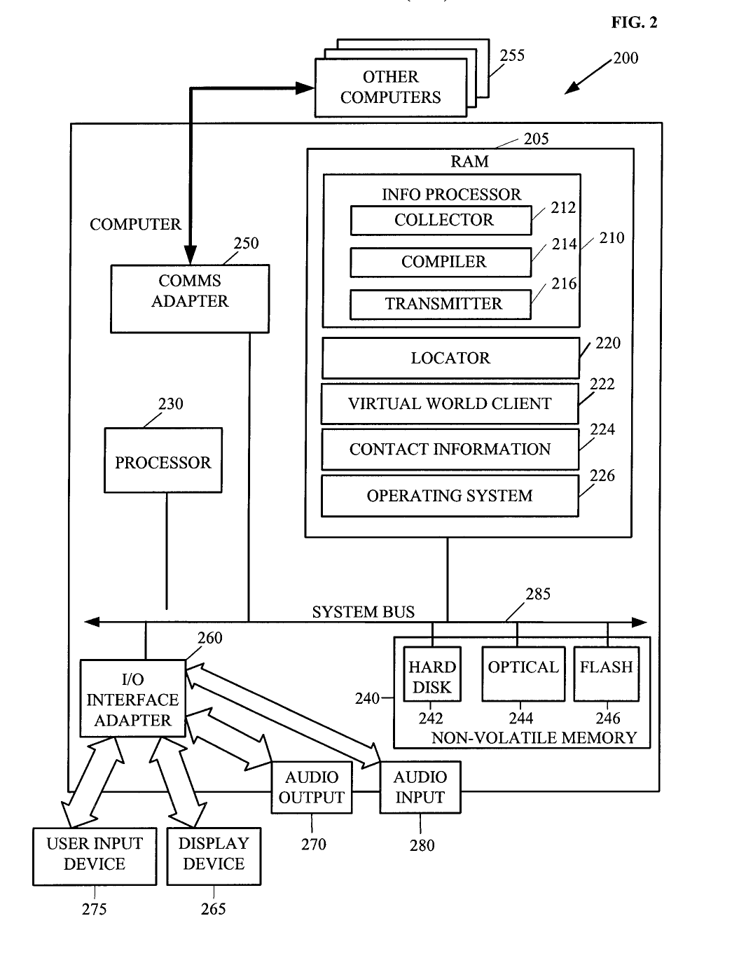

Turning to FIG. 2, depicted is an embodiment of a computer 200 capable of locating objects in virtual worlds that includes random access memory (RAM) 205, a processor 230 or CPU, non-volatile memory 240, a communications adapter 250, and an Input/Output (I/O) interface adapter 260 connected by system bus 285. Stored in RAM 205 is information processor 210, locator 220, virtual world client 222, contact information 224, and operating system 226.

Information processor 210 may comprise computer program instructions to gather information, such as contact information about potential participants, for locating objects in virtual worlds. Information processor 210 includes collector 212, compiler 214, and transmitter 216. Collector 212 may receive from a user a criterion for gathering information for use in determining a location of an object of the user's in a virtual world. The criterion may include a source of the information and a specification of the information to be gathered from the source. For example, a user may desire for the user's avatar to appear near the avatars of friends. The user may provide collector 212 with a source of contact information for the friends, such as an address book or a list of friends in a social network. In addition, the user may specify which contacts to look up in the virtual world. For example, the user may look up first-level friends or contacts with a field marked “VW” in the address book. In the embodiment of FIG. 2, the sources of information are separate from, or external to, the virtual world. The sources may be maintained by a program other than virtual world programs, such as an email program or a web browser. Collector 212 may automatically gather information, such as contact information, from the specified sources.

Compiler 214 may aggregate the data gathered by collector 212 into a uniform format. For example, the representation of a contact may include the contact's name, email address, source of information, phone number, and interests. The representation may be in the form of an XML document, straight text, or another form of representation.

Transmitter 216 may transmit the representation produced by compiler 214. The transmission may be sent directly to the virtual world, or may be sent to an intermediary, such as a web service, for further processing. In some embodiments, the recipient may return a list of avatars corresponding to the contact information and their current locations, if any, in the virtual world. Using this list of avatars and locations, locator 220 may determine a location for the user's avatar or an object of the user in a virtual world. Locator 220 may, for example, select the region containing the most avatars on the list.

Virtual world client 222 may comprise computer program instructions for interacting with a virtual world. Virtual world client 222 may transmit user input to the virtual world, and may process transmissions from the virtual world for output on a device such as display device 265 or audio output 270.

Contact information 224 may contain information, such as contact information, useful for locating avatars or other objects in virtual worlds. Contact information may include data stored in communications applications, such as address books in email or instant message applications; and may include data accessible through a web site, such as friends' lists in social networking sites. Examples of information include:
address books
communications history
social networking web sites, including but not limited to, LinkedIn, Friends Reunited, MySpace, Windows Live Spaces, orkut, hi5, Friendster, Xanga, Classmates.com, Bebo, Facebook, Reunion.com, and Broadcaster.com
newsgroups
chat rooms
tagged websites or folksonomies
friends' lists
user interests
non-virtual world tagged websites or folksonomies
bookmarks
recently emailed friends
blogs
integrated e-mail (Yahoo, Gmail, Hotmail).
   A software agent or other module may automatically gather data from these sources by extracting elements of data on the basis of general directions from a user, or even in the absence of directions from a user. The agent may, for example, select all names from a friends' list or all addresses from an address book which have an “Avatar” field filled in.

Address books may contain lists of associates, with names, email addresses, and other contact information. Some address books may identify participants in virtual worlds. For example, a field may contain the name of the entry's avatar, or a tag such as “VW” to indicate the person corresponding to the entry participates in a virtual world. A member of a social networking site may maintain a list of friends or links. Some sites may keep track of the number of direct links between the member and another member (the distance or degree of separation). In other sites, there may be categories of associates, such as Friend or Colleague. Some sites may make available lists of people and their interests.

A participant in a virtual world may provide to collector 212 a criterion for selecting information on other participants to meet in the virtual world. The criterion may include address book entries with a specified field value such as “VW”, address book entries with a value in a specified field, certain categories of associates in a social networking site, people in a social networking site with specified interests, and other criterion as may occur to those of skill in the art.

Operating system 226 may comprise UNIX™, Linux™, Microsoft Windows™, AIX™, IBM's i5/OS™, or other operating systems useful for locating objects in virtual worlds as will occur to those of skill in the art. Information processor 210, locator 220, virtual world client 222, contact information 224, and operating system 226 (components of software) are shown in RAM 205 in FIG. 2, but many components of such software may be stored in non-volatile memory 240 also. Further, while the components of such are shown simultaneously present in RAM, in some other embodiments, only some of the components of RAM 205 may be present at any given time.

The modules shown in RAM 205 are for explanation, not for limitation. In many other embodiments, information processor 210 may constitute a component of virtual world client 222. In some embodiments, a virtual world client may be omitted. For example, a user may interact with a virtual world through a web browser. In a few embodiments, an information processor or virtual world client may identify virtual world avatars corresponding to contact information aggregated by a compiler 214. The module may obtain from the virtual world a list of avatars and contact information, and may match the contact information produced by a compiler 214 with the avatar contact information. Some embodiments may omit a locator. A remote module, such as a web service or the virtual world server, may determine a location of the user's avatar or objects of the user in a virtual world. The remote module may receive from an information processor the user's metric for determining the best location of an avatar.

Non-volatile computer memory 240 may be implemented as a hard disk drive 242, optical disk drive 244, electrically erasable programmable read-only memory space (EEPROM or Flash memory) 246, RAM drives (not shown), or as any other kind of computer memory as will occur to those of skill in the art. Communications adapter 250 may implement the hardware level of data communications between computer 200 and other computers, such as other computers 255. The data communications may occur directly or through a network and may include communicating with a virtual world server or web service server. Such data communications may be carried out through serially through RS-232 connections, through external buses such as USB, through data communications networks such as IP networks, and in other ways as will occur to those of skill in the art. Examples of communications adapters include modems for wired dial-up communications, Ethernet (IEEE 802.3) adapters for wired network communications, and 802.11a/b/g/n adapters for wireless network communications.

I/O interface adapter 260 implements user-oriented I/O through, for example, software drivers and computer hardware for controlling output to display devices such as display device 265 and audio output device 270 as well as user input from user input device 275 and audio input device 280. User input device 275 may include both a keyboard and a mouse. Some embodiments may include other user input devices such as speech interpreters, bar code scanners, text scanners, tablets, touch screens, and/or other forms of user input devices. Audio output 270 may include speakers or headphones and audio input device 280 may include a microphone or other device to capture sound.

The computer and components illustrated in FIG. 2 are for explanation, not for limitation. In other embodiments, embedded systems, PDAs, cell phones, BlackBerries® and other computing devices which can connect to a network may locate objects in virtual worlds. In other embodiments, modules to locate objects in virtual worlds may be implemented in hardware, firmware, or in state machines or may form a component of an operating system.

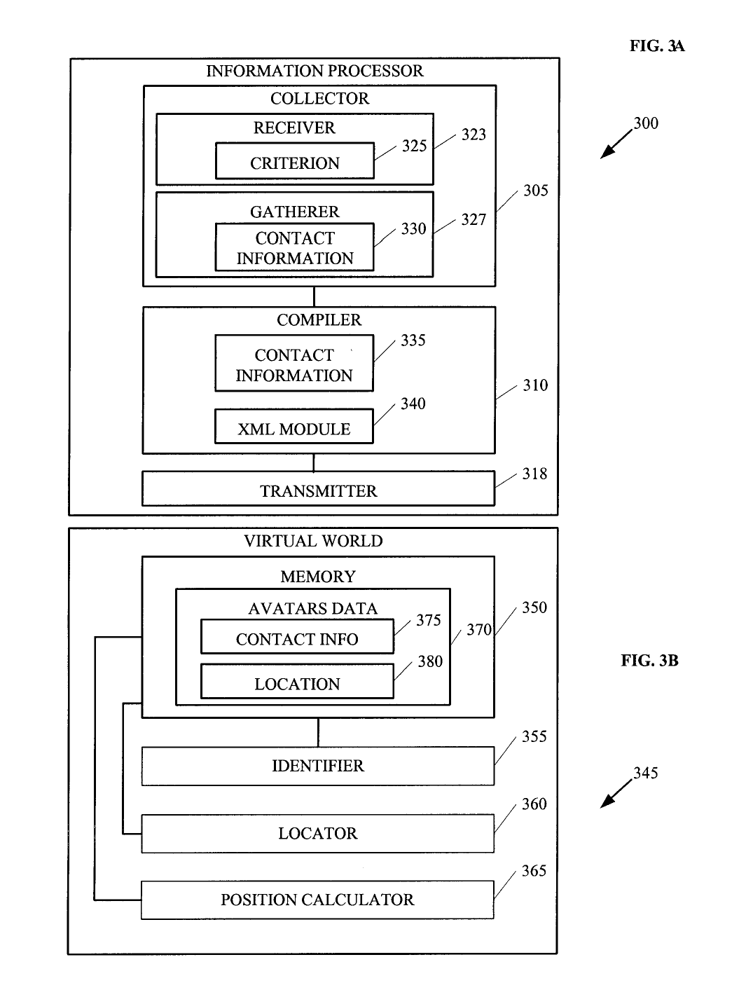

For further explanation, FIG. 3A sets forth a block diagram illustrating an exemplary apparatus 300 to gather information for locating objects in virtual worlds. Information processor 300 may gather and organize information from non-virtual world sources and transmit the information to another module for the location of avatars and other objects. Information processor 300 includes collector 305, compiler 310, and transmitter 318. Collector 305 includes receiver 323 and gatherer 327. Receiver 323 may receive from a user a specification of a criterion for collecting information from a source external to a virtual world. In many embodiments, the source may contain contact information about other potential participants in the virtual world. Some embodiments of sources may be contained on the user's local computer system, such as address books or lists of recent instant message contacts. In other embodiments, the source may be accessible over a network. For example, the source may consist of a user's friends list in a social networking web site. Receiver 323 may store the criterion in criterion 325.

Gatherer 327 may gather data from the sources specified in criterion 325. In the embodiment of FIG. 3A, gatherer 327 stores the collected information in contact information 330. Gatherer 327 may comprise a set of daemons or software agents installed on non-virtual world systems. In some embodiments, a software agent may run on a user's local computer system and may check for updates to information that is stored on the local computer system. The software agent may include a menu to allow the user to specify sources to be checked for updates. The software agent may be synchronous, for example running at certain intervals, or may be event driven. In an event driven mode, software that houses a data source may have a hook or plug in into the software agent to initiate the collecting of information for use in locating objects in the virtual world. The software agent may be registered as a handler of the event. When an event in the data source occurs, such as adding information to the data store, the software housing the data source may pass control to the software agent. It may check for updates and may return control to the data store.

Compiler 310 may assemble the information collected by collector 305 and reformulate it into a uniform representation. Compiler 310 may perform the functions of the program compiler 214 from FIG. 2. Compiler 310 may run on the client side, perhaps on a user's computer system, or as a shared service provided by the virtual world provider. Although compiler 214 consists of software, compiler 310 may consist of software, hardware, or a combination of both. Compiler 310 includes contact information 335 and XML module 340. Contact information module 335 may store the contact information aggregated by compiler 310.

XML module 340 may create an XML document embodying the representation of the information gathered by gatherer 327. The XML document may, for example, contain tags to describe the information. The tags may include a specification of the fields of a data entry. For example, an address book entry may indicate a source of Outlook Express address book, and fields of email address, name, and home phone number.

Transmitter 318 may transmit the data produced by compiler 310 and may in response receive information used for determining locations for objects of the user in the virtual world. In some embodiments, transmitter 318 may transmit a representation of contact information to the virtual world, a web service, or another intermediary. The contact information may be used to identify avatars in the virtual world, either by the recipient of the transmission or another processor.

Turning to FIG. 3B, depicted is a block diagram illustrating a virtual world 345 capable of positioning objects of a user based upon information automatically gathered from sources external to the virtual world. Virtual world 345 includes memory 350, identifier 355, locator 360, and position calculator 365. Memory 350 includes avatars data 370, the data stored about avatars. Avatars data 370 includes contact information 375 and location 380. Contact information 375 may contain contact information about users corresponding to avatars. Users may provide the information when they join the virtual world, and the information may be part of the users' profiles. Location module 375 stores information about which users are currently on line, and where their avatars are located. Location module 375 may constantly update the location information. The location information may be used to display the virtual world.

Identifier 355 may identify avatars of one or more of the potential participants based upon information provided by a module such as information processor 300 of FIG. 3A. In some embodiments, identifier 355 may identify avatars by matching contact information provided by an information processor with contact information 375. For example, a MySpace software agent may detect that ‘Jim Smith’ is a known person that the user would like to associate with in the virtual world. An information processor may transmit the name to identifier 355. Identifier 355 may examine contact information 375 to determine whether ‘Jim Smith’ is a registered avatar within the virtual world. This mapping of contact information to avatar may be based on name, address and other information. The MySpace information retrieved may also include the associated avatar's name. For example, Jim Smith's avatar may be called ‘James Virtualman’.

Locator 360 may determine a place for rendering or teleporting an avatar or other object of the user. A user may desire to interact with friends, associates, or other participants in the virtual world. Accordingly, the user may desire to collocate the user's avatar and the avatars of the friends or associates. Locator 360 may receive from identifier 355 a list of avatars of virtual world participants that the user is interested in meeting in the virtual world. Locator 360 may check the data of location 380 to determine which avatars are currently online and their locations.

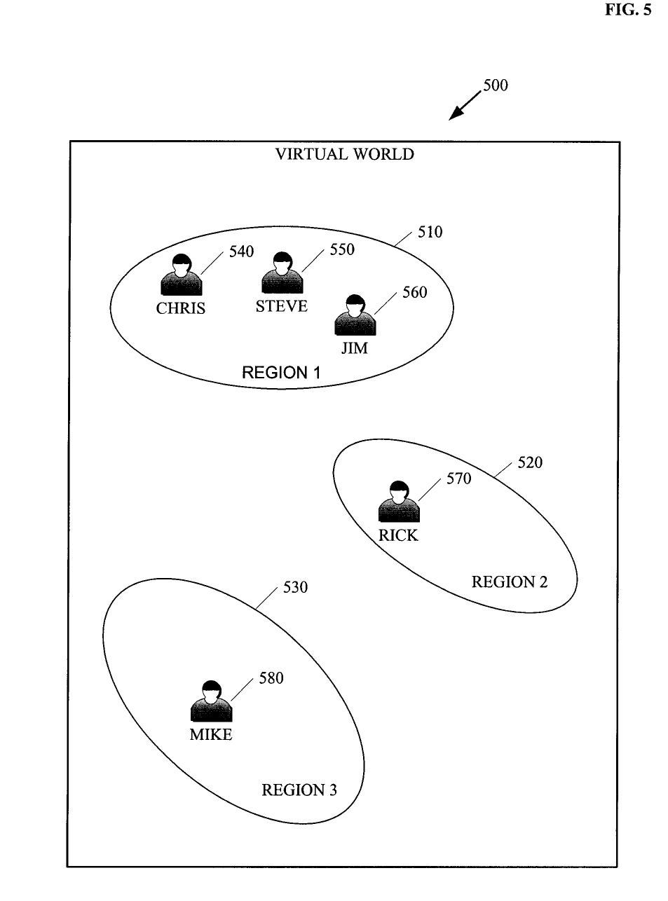

Locator 360 may then determine a location for the user's avatar based upon the locations of the other avatars. In some embodiments, the location may be by some measure closest to the other avatars of interest. In some embodiments, locator 360 may select a region that contains a maximum number of other avatars. Turning to FIG. 5, shown is an example of the distribution of avatars in a virtual world. Virtual world 500 includes three regions, region 1 (510), region 2 (520), and region 3 (530). Region 1 contains 3 avatars of interest to the user, Chris 540, Steve 550, and Jim 560. Regions 2 and 3 each contain one avatar of interest to the user, Rick (570) and Mike (580) respectively. Under the above rule, the user's avatar should be rendered in region 1—collocated with Chris, Steve and Jim—when the user enters the virtual world.

Other embodiments may use other methods of basing a location on the distributions of other avatars. For example, some embodiments may select the geographic center of the other avatars of interest as the best location. A few embodiments may select a location within a fixed distance of the maximum number of avatars. Further embodiments may select a location at a minimum total distance from those avatars.

In addition to distance from the avatars, locator 360 may determine a location based upon the relative importance of the avatars to the user. In some embodiments, avatars may be categorized. In some further embodiments, locator 360 may attempt to select a location based upon more important categories before considering less important categories. For example, the user may tag an address book entry in the non-virtual world environment to indicate the addressee's avatar is important or that the user's avatar should, if possible, be collocated with the addressee's avatar. In these further embodiments, locator 360 would attempt to select a location near one of the important avatars. If none were currently online, locator 360 would look at the location of less important avatars. In other further embodiments, the importance of an avatar may be used as a weight. Locator 360 may attempt to select a location which minimizes the weighted sum of the distances to the avatars. In some of these embodiments, the weight of an avatar may consist of the relative distance of the avatar from the user. Avatars which have been identified as belonging to a contact three steps away in a LinkedIn network may have a lower priority and lower weight than those which belong to contacts with a direct connection. In other of these embodiments, some categories may have a higher weight and priority than others. For example, Colleagues may have a higher priority than Friends. In further embodiments, this categorization may be customizable by the user and may change based on time of day.

Consider the following examples illustrate the locating of avatars and other objects:
Chris is a local user with accounts at MySpace and LinkedIn® and a local personal address book. The MySpace account shows that Chris talks frequently to Mike and Jim. The LinkedIn network shows an affiliation with a colleague, Rick. The personal address book shows multiple other people including John, Dick and Harry. Assume that each of these contacts also has an associated avatar within the same virtual world environment. Chris would like to enter the virtual world. In many virtual worlds, the default location for an avatar on the user's entry is the last place the avatar was rendered. No associated avatars are in the vicinity of that location. A locator discovers that Mike and Jim are currently online and are in the same place within the virtual world. John is also available, but is in a different place within the virtual world. Chris's avatar is therefore automatically teleported to the same location as Mike's and Jim's.
Chris owns a virtual apartment within the virtual world. This apartment is part of a collection of apartments similar to that of an apartment complex. When Chris enters the virtual world, his apartment is rendered on the same floor as Mike's and Jim's.
The local personal address book shows that Chris has a meeting scheduled at 1:00 PM with John and Harry. John and Harry have scheduled the meeting to take place in a specific place within the virtual world. Chris is already in the virtual world. 10 minutes before the meeting, Chris is given a message that he should teleport to the location of the meeting.
Webkinz® offers juvenile users virtual homes, the complexity of which increase as the users buy additional goods and services. These virtual homes may be collocated with the homes of users of similar interests, based on social tags or networks to which a user subscribes.

Position calculator 365 may calculate and maintain the positions of avatars and other objects in a virtual world. In response to a user action, position calculator 365 may determine the new position of the user's avatar. For example, as the user moves an avatar through a region step by step, position calculator 365 may determine and keep track of the new position resulting from each step. When a user moves an avatar through a portal in a video game, moving the avatar to another region, position calculator 365 may determine the new position, the one at the other end of the portal. Similarly, when a user teleports an avatar, position calculator 365 may again determine and note the new position. In some embodiments, position calculator 365 may determine the position at which an avatar appears when the user enters the virtual world. In further embodiments, position calculator 365 may receive a position for an avatar or other object from a module such as locator 360. In response, position calculator 365 may set the received position as the position for the object. The calculations of position calculator 365 may be used to create a display of the portion of the virtual world which contains the user's avatar and may be used to update the data in location module 380.

The locating of objects in virtual worlds based upon the automatic gathering of information may enable multiple avatars to stay connected more frequently and may prevent missing events in the virtual world. In the current art, it may be difficult for multiple avatars with a common association or interest to meet within the virtual world. In addition, in the current art, there is a danger that events such as a meeting with other avatars may be missed when a user is immersed in the virtual world.

The modules of FIGS. 3A and 3B are for illustration and not limitation. An apparatus for locating objects in virtual worlds in accordance with embodiments of the invention may omit some of the modules shown, may include additional modules, or may contain different arrangements of modules. In other embodiments, some of the functions of an information processor and a virtual world may be differently divided, or may be contained in other modules, as may occur to those of skill in the art. In some embodiments, a gatherer of information for use in locating an avatar may be contained in a virtual world client. In a few embodiments, an identifier may be contained in a local software agent or in an intermediate module such as a web service. In these embodiments, the identifier may receive from a virtual world contact information about registered avatars. The identifier may compare the virtual world contact information with contact information about desired contacts in the virtual world. Similarly, in several embodiments, a locator may be contained in a local software agent or an intermediate module. The locator may receive from the virtual world information about the current location of avatars of interest to a user.

Some embodiments of a collector may not require a user to provide a criterion. The collector may have a default source of information, such as the default email address book and instant message history. Further embodiments may dispense with a receiver entirely. In some embodiments, a transmitter may not transmit information for locating objects every time an object is to be located or every time the user joins the virtual world. Instead, the information may be stored. The transmitter may send updates when the information changes.

In some embodiments, in addition to determining an initial placement of a user's avatar or other objects, a locator may contain an update component to determine if a change in location is desirable. In order to make these determinations, an update component may automatically track the location of an avatar and may monitor both virtual world data and non-virtual world data. In some further embodiments, the update component may track time-critical non-virtual world information, such as calendar entries, to-do lists, and birthdays or other function lists. The non-virtual world information collected may include location information such as the name or place of a meeting within an address book. For example, at 12:00 PM, a meeting may be scheduled in the virtual world at a specific location. The update component may determine that a change in location is desirable if it detects that a meeting involving people with avatars currently online is about to start in a location away from the current location of a user's avatar. In some further embodiments, the update component may send a message about the meeting to the virtual world provider through a standard communication channel. This message may be accepted by the virtual world provider and used to signal to the avatar that a change in location could be beneficial. The message may offer to teleport the avatar to the meeting location. In other embodiments, the update component may arrange for the teleportation of the avatar to the desired location without first offering the user the option of relocating. In further of these embodiments, the update component may notify the user of the teleportation and may explain its rationale.

An update component may also base relocation decisions upon the changing locations of avatars of interest to a user in the virtual world, and their movement in and out of the virtual world. The component may determine that a change in location is desirable if an avatar belonging to an associate of the user joins the virtual world or if an avatar of an associate in the vicinity of the user's avatar leaves the virtual world or teleports elsewhere. An upgrade component may be implemented to run just before a user enters a virtual world, as a batch-drive module or as an event-driven module. The events may include an upcoming meeting, a new person joining the user's list of friends in a social networking web site, or other information that could affect the best location for the avatar to be rendered.

A compiler may create a representation in formats other than XML. The formats may include extensions of XML, such as XBase, XLink, XInclude, XSL (Extensible Stylesheet Language), XSLT (Extensible Stylesheet Language Transformations), XPointer, XML Query, and SOAP (Simple Object Access Protocol). The formats may also include non-XML formats, such as straight text.

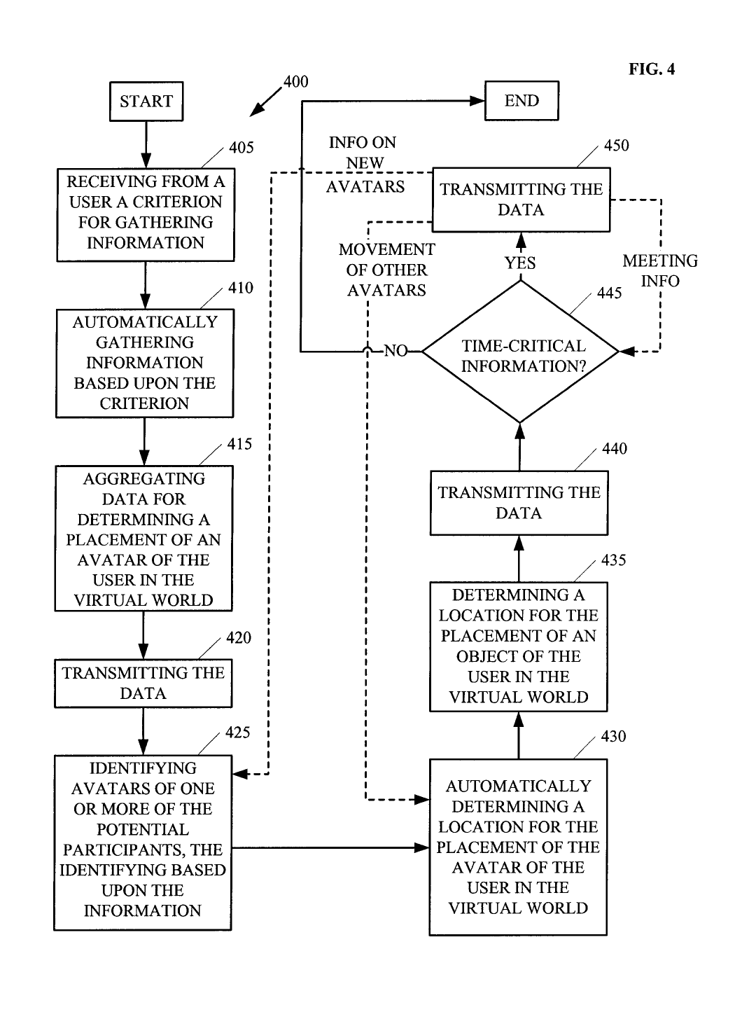

FIG. 4 depicts a flowchart 400 of an embodiment of a method to locate objects in virtual worlds. In some embodiments, elements 405 through 420 of flowchart 400 may be performed by an apparatus such as information processor 300 of FIG. 3A, and elements 425 through 450 may be performed by an apparatus such as virtual world 345 of FIG. 3B. Flowchart 400 of FIG. 4 begins with receiving from a user a criterion for gathering information (element 405) to be used for locating objects in a virtual world. The criterion may describe a source of information and the types of entries to collect. In some embodiments, the sources may include blogs, chat rooms, social networking websites, folksonomies, and address books.

The method may include automatically gathering data based upon the criterion (element 410). The gathering may be performed by a software agent, which may search through a data source or data sources on a local computing device as specified by the criterion. For example, the software agent may collect entries from an address book that are tagged with the abbreviation “VW” or a list of friends from a social networking site that are within three degrees of separation from the user. The gathering may be periodic or event-driven.

The method may include aggregating data for determining a placement of an avatar of the user in the virtual world (element 415). The aggregating may include putting entries from a variety of sources into a uniform representation, such as an XML document. It may also include eliminating duplication. For example, both an address book and a friends' list in a social networking site may contain an entry for the same friend. The method may include transmitting the data (element 420) to an identifier. The identifier may convert the gathered information into virtual world data that can be used for locating objects. For example, the identifier may identify avatars of one or more of the potential participants, based upon contact information (element 425).

The method may include automatically determining a location for a placement of the avatar of the user in the virtual world (element 430). The placement may be the placement immediately after the user enters the virtual world. In many embodiments, the determining may be based upon locations of the identified avatars. In some embodiments, the initial location may be a region of the virtual world that contains the most avatars representing participants associated with the user. In many embodiments, the importance of the associated avatars may affect determining a location for the user's avatar. It may be more important to be located near some avatars than others.

The method may include determining a location for a placement of an object of the user in the virtual world, such as the user's dwelling (element 435). For example, a user's apartment may be located on the same floor as the apartments of associates. In some embodiments, the method may include transmitting the placement information (element 440). For example, a web service may receive contact information from a software agent on the user's local computer, communicate with a virtual world to obtain information about where to locate an avatar, and transmit back to the virtual world a desired location of the avatar.

If there is time critical information (element 445), such as information about an upcoming meeting in the virtual world, or new information about associates of the user, the information may be transmitted (element 450). The destination depends upon the type of information. Information about an upcoming meeting may be transmitted to the virtual world for relay to the user. The user may arrange to teleport to the meeting. Contact information about a new potential participant in the virtual world may be transmitted to a module for identification of an associated avatar. Information about a change of location of an associated avatar may be transmitted to a module which determines a location for the user's avatar. Otherwise, if there is no unprocessed time-critical information, the method of flowchart 400 may end.

The elements of flowchart 400 are for illustration and not for limitation. In alternative embodiments, additional elements may be included, some of the elements of flowchart 400 may be omitted, or the elements may be performed in a different order.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product for locating objects in virtual worlds, the computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

It will be apparent to those skilled in the art having the benefit of this disclosure that the present invention contemplates methods and arrangements for locating objects in virtual worlds. It is understood that the form of the invention shown and described in the detailed description and the drawings are to be taken merely as examples. It is intended that the following claims be interpreted broadly to embrace all the variations of the example embodiments disclosed.

Although the present invention and some of its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of locating objects in virtual worlds, the method comprising:
receiving from a user a criterion for gathering information, the information comprising contact information of potential participants in a virtual world;
automatically gathering information based upon the criterion, the gathering external to the virtual world;
aggregating data for determining a placement of an avatar of the user in the virtual world, the data based upon the automatically gathered information; and
transmitting the data.

2. The method of claim 1, further comprising identifying avatars of one or more of the potential participants, the identifying based upon the automatically gathered information.

3. The method of claim 1, further comprising automatically determining a location for a placement of the avatar of the user in the virtual world, the determining based upon the automatically gathered information.

4. The method of claim 3, wherein the determining comprises determining a location for a placement of an object of the user other than the avatar of the user in the virtual world.

5. The method of claim 1, wherein:
the gathering comprises gathering information about meetings in a virtual world; and
the aggregating comprises aggregating data for determining a placement of an avatar of the user in the virtual world, the determining based on the gathered information about meetings.

6. The method of claim 1, wherein the gathering comprises gathering information from one or more of the following types of data sources:
address books;
communications history;
social networking web sites;
newsgroups;
chat rooms;
tagged web sites;
bookmarks;
blogs; and
integrated email.

7. A method of locating objects in virtual worlds, the method comprising:
receiving in a virtual world from a software agent automatically gathered information, the information comprising information about contacts of a participant in the virtual world, the information gathered external to the virtual world; and
determining a location for a placement in the virtual world of an avatar of the participant, the determining based upon the automatically gathered information.

8. The method of claim 7, further comprising identifying avatars of one or more other participants in the virtual world, the identifying based upon the automatically gathered information.

9. The method of claim 8, wherein the determining is based upon locations of the identified avatars.

10. An apparatus to place avatars in virtual worlds, the apparatus comprising:
a collector to receive from a user a criterion for gathering information external to a virtual world, the information comprising contact information of potential participants in a virtual world, and to automatically gather information based upon the criterion;
a compiler to aggregate data for determining a placement of an avatar of the user in the virtual world, the data based upon the information gathered by the collector; and
a transmitter to transmit the aggregated data.

11. The apparatus of claim 10, the apparatus comprising an identifier to identify avatars of one or more of the potential participants, the identifying based upon the information gathered by the collector.

12. The apparatus of claim 10, the apparatus comprising a locator to automatically determine a location for a placement of an avatar of the user in the virtual world, the determining based upon locations of identified avatars.

13. The apparatus of claim 10, wherein the collector, the compiler, and the transmitter comprise a collector, a compiler, and a transmitter contained within a local computer of the user.

14. A computer program product to locate objects in virtual worlds, the computer program product comprising a computer useable medium having a computer readable program, wherein the computer readable program when executed on a computer causes the computer to:
receive from a user a criterion for gathering information, the information comprising contact information of potential participants in a virtual world;
automatically gather information based upon the criterion, the gathering external to the virtual world;
aggregate data for determining a placement of an avatar of the user in the virtual world, the data based upon the automatically gathered information; and
transmit the data.

15. The computer program product of claim 14, wherein the computer readable program when executed on a computer further causes the computer to identify avatars of one or more of the potential participants, the identifying based upon the contact information.

16. The computer program product of claim 14, wherein the computer readable program when executed on a computer further causes the computer to automatically determine a location for a placement of an avatar of the user in the virtual world, the determining based upon the automatically gathered information.

17. The computer program product of claim 14, wherein the computer readable program which causes the computer to automatically determine a location comprises a computer readable program which causes the computer to determine a location for a placement of an object of the user other than the avatar of the user in the virtual world.

18. The computer program product of claim 14, wherein:
the computer readable program which causes the computer to gather comprises a computer readable program which causes the computer to gather information about meetings in the virtual world; and
the computer readable program which causes the computer to aggregate comprises a computer readable program which causes the computer to aggregate data for determining a placement of an avatar of the user in the virtual world, the determining based on the gathered information about meetings.

19. The computer program product of claim 14, wherein the computer readable program which causes the computer to gather comprises a computer readable program which causes the computer to gathering contact information from one or more of the following types of data sources:
address books;
communications history;
social networking web sites;
newsgroups;
chat rooms;
tagged web sites;
bookmarks;
blogs; and
integrated email.

20. The computer program product of claim 14, wherein the computer useable medium comprises a transmission medium.
